(19) United States
(12) Patent Application Publication
(10) Pub. No.: US 2015/0046215 A1
(43) Pub. Date: Feb. 12, 2015

(54) SCORING SALES LEADS IN A SALES LEAD MARKETPLACE

(71) Applicant: Upcycle Data LLC, Denver, CO (US)

(72) Inventor: Denton Crofts, Denver, CO (US)

(21) Appl. No.: 14/454,599

(22) Filed: Aug. 7, 2014

Related U.S. Application Data
(60) Provisional application No. 61/864,185, filed on Aug. 9, 2013.

(51) Int. Cl. G06Q 30/02; G06F 17/30

(52) U.S. Cl. CPC G06Q 30/0201; G06Q 30/0283; G06F 17/30861
USPC 705/7.29

(57) ABSTRACT

Systems and methods are disclosed to receive at a computing system user entered data that was entered by a first user into a plurality of data entry fields published by a first webpage hosted by a first webserver. The user entered data may comprise at least first data entered into a first field of the plurality of data entry fields, second data entered into a second field of the plurality of data entry fields, and third data entered into a third field of the plurality of data entry fields. The computing system may compute a data score based on a function including at least the first data and the second data. The data score and the first data may be published on a second webpage hosted by a second webserver, but not publishing the second data on the second webpage.

### SUMMARY

Embodiments described herein are directed toward a sales lead marketplace. In some embodiments described herein, information about a sales lead can be received at the marketplace and a lead score and/or a suggested lead price can be determined based on the information received about the sales lead. A listing offering the sales lead for sale through a marketplace including either or both the lead score and/or the suggested lead price can be published. The listing can include a first subset of the information about the sales lead and/or can provide an indication that a second subset of the information is available but not published. An indication that a buyer has purchased the lead can be received. In response, the second subset of the information can be provided to the buyer.

In some embodiments, a first data element about a lead can be received and a lead score can be determined based on the first data element. A second data element about a lead can be received and the lead score can be modified based on the first data element. The lead along with the lead score can be published. A suggested lead price can also be determined based on the lead score and published along with the lead price.

In some embodiments, a system may include one or more processors and one or more non-transitory, tangible computer readable mediums communicatively coupled to the one or more processors and storing executable instructions executable by the one or more processors to perform or control performance of operations comprising: receiving user entered information from a first user through a network; computing an information score and an information price based on at least a first subset of the user entered information; publishing the information score and the information price in a manner that is accessible by a plurality of users through the Internet and in a manner such that at least a second subset of the user entered information is available but not published; receiving an indication that a second user has paid the information price; and providing the second subset of the user entered information to the second user through the network.

In some embodiments, the user entered information may include a contact name information associated with the data, company name information associated with the data, company size information associated with the data, contact title information associated with the data, a contact phone number associated with the data, a contact email address associated with the data, a company phone associated with the data, a company address associated with the data, a company webpage associated with the data, a name of a lead associated with the data, a lead type associated with the data, a description associated with the data, a gross sales value associated with the data, a sales margin associated with the data, time information associated with the data, and/or notes associated with the data.

In some embodiments, the information score may be computed based on a User Score associated with the first user, wherein the User Score indicates the trustworthiness of the first user. In some embodiments, the User Score may be computed based one or more data selected from the list consisting of a peer review score of the first user, an activity level indication of the first user, feedback about the first user from other users, a number indicating the number of leads sold by the first user, a number indicating the number of leads purchased first user, and an amount of personal data the first user has entered into the system.

In some embodiments a method is disclosed. The method may include receiving at a computing system user entered data that was entered by a first user into a plurality of data entry fields published by a first webpage hosted by a first webserver, wherein the user entered data comprises at least first data entered into a first field of the plurality of data entry fields, second data entered into a second field of the plurality of data entry fields, and third data entered into a third field of the plurality of data entry fields; computing at the computing system a data score based on the first data and the second data; and publishing the data score and the first data on a second webpage hosted by a second webserver, but not publishing the second data on the second webpage.

In some embodiments, the method may include publishing information on the second webpage indicating that the second data is available but not published. In some embodiments, the method may include receiving an indication that a second user has purchased access to the second data; and publishing the second data on a third webpage that is accessible to the second user. In some embodiments, the computing the data score based on the first data and the second data may include determining a number of characters comprising the first data; and computing the data score based on the number of characters.

In some embodiments, the data score may be computed based on a sliding scale of the first data. In some embodiments, the method may include receiving an indication that a second user has purchased access to the second data; and sending an email including the second data to the second user via email. In some embodiments, the third data may include a value associated with the user entered data. In some embodiments, the method may include determining a suggested lead price from the data score and the third data; and publishing the suggested lead price on the second webpage hosted by the second webserver.

In some embodiments, the method may include publishing the third data on the second webpage hosted by the second webserver. In some embodiments the first webserver and the second webserver comprise the same webserver or the same plurality of webservers.

In some embodiments, the data score may be computed based on a User Score associated with the first user, wherein the User Score indicates the trustworthiness of the first user. In some embodiments, the User Score is computed based one or more data selected from the list consisting of a peer review score of the first user, an activity level indication of the first user, feedback about the first user from other users, a number indicating the number of leads sold by the first user, a number indicating the number of leads purchased first user, and/or an amount of personal data the first user has entered into the system.

In some embodiments, the first data, the second data, and/or the third data may include contact name information associated with the data, company name information associated with the data, company size information associated with the data, contact title information associated with the data, a contact phone number associated with the data, a contact email address associated with the data, a company phone associated with the data, a company address associated with the data, a company webpage associated with the data, a name of a lead associated with the data, a lead type associated with the data, a description associated with the data, a gross sales value associated with the data, a sales margin associated with the data, time information associated with the data, and/or notes associated with the data.

In some embodiments a method is disclosed. The method may include receiving at a computer system user entered information from a first user through a network, wherein the user entered information includes contact information and value information associated with at least a subset of the user entered information; determining a User Score associated with the first user that indicates the trustworthiness of the first user; computing at the computing system an information score based at least in part on the contact information and the User Score; computing at the computing system an information price based at least in part on the value information; publishing the information score and the information price in a manner that is accessible by a plurality of users through the Internet and in a manner where at least a second subset of the user entered information is available but not published; receiving an indication that a second user has paid the information price; and providing the second subset of the user entered information to the second user through the network.

### BRIEF DESCRIPTION OF THE FIGURES

These and other features, aspects, and advantages of the present disclosure are better understood when the following Detailed Description is read with reference to the accompanying drawings.

FIG. 1 is a block diagram of a marketplace coupled with a database, sellers, and buyers according to some embodiments described herein.

FIG. 2 is a flowchart of a process for determining a suggested Lead Score according to some embodiments described herein.

FIG. 3 is a flowchart of a process for selling a lead according to some embodiments described herein.

FIG. 4 is an example of a home page of a webpage providing a sales lead marketplace according to some embodiments described herein.

FIG. 5 is an example of a sign up page of a webpage providing a sales lead marketplace according to some embodiments described herein.

FIG. 6 is an example of a web page for entering personal information of a webpage providing a sales lead marketplace according to some embodiments described herein.

FIG. 7 is an example of a user's profile page shot of a webpage providing a sales lead marketplace according to some embodiments described herein.

FIG. 8 is another example of a user's profile page shot of a webpage providing a sales lead marketplace according to some embodiments described herein.

FIG. 9 is an example of a webpage with a listing of leads that a user can purchase according to some embodiments described herein.

FIG. 10 is an example of a webpage where a user can provide information about a lead they are selling according to some embodiments described herein.

FIG. 11 is an example of a webpage listing leads a user has sold according to some embodiments described herein.

FIG. 12 is an example of a home page of a webpage providing a sales lead marketplace according to some embodiments described herein.

FIG. 13 is an example of a webpage with a listing of leads that a user can purchase according to some embodiments described herein.

FIG. 14 is an example sign up page for selling or buying leads according to some embodiments described herein.

FIG. 15 is an example webpage having a plurality of fields that may receive data about a potential sales lead from a user according to some embodiments described herein.

FIG. 16 shows an illustrative computational system for performing functionality to facilitate implementation of embodiments described herein.

### DETAILED DESCRIPTION

Systems and methods are disclosed to provide a marketplace for sales leads and/or scoring sales leads based on a plurality of data. In some embodiments, the sales leads provided in the marketplace can be considered “hot leads” that include specific contact that is interested in purchasing a specific product or service or to satisfy a specific need or requirement. In some embodiments, a sales lead can be posted to a marketplace with a price that is automatically set based on various factors related to the lead such as, for example, the amount and/or quality of information provided by the seller about the lead. In some embodiments, a sales lead can be posted to a marketplace that includes only a description of the lead but does not include all the details of the lead. The description of the lead can include a generic description the detailed and/or specific information about the lead will be provided to the buyer upon purchase of the lead. When a lead is purchased, various details related to the lead can be provided to the purchaser in exchange for payment for the lead.

A salesperson is employed to sale a specific product or service to buyers. Often, a salesperson's contacts and relationships with potential buyers or people in a given industry are the seeds that grow into a sale. These relationships are cultivated over time, often during periods when the contact is not interested in buying the goods or services being sold by the salesperson. A salesperson that is selling product A, for example, may be talking with a contact and learn that the contact is interested in buying service B, which is not a service offered by the salesperson. Embodiments described herein allow the salesperson to sale information about this lead for service B to other salespeople through an online marketplace. In this way, the salesperson can not only earn money, but help connect their contact with salespersons that may be selling service B; and the purchasing salesperson will be provided with contact information for a person that is interested in buying a specific product that they sell. Such a lead is often called a “hot lead”. Embodiments described herein, therefore, can provide an efficient marketplace where hot leads are shared with other salespersons that up prospective buyers with the proper salesperson.

Leads can be categorized, ranked or presented with a number of scores or factors. These may include such things as, for example, a User Score, Lead Score and/or Lead Price. The User Score, for Example, may be a score or rating for each and every user and, in particular, the user selling a lead. The User Score may be calculated, for example, based on a sum or weighted sum of all ratings of a user. The Lead Score, for example, may be a rating associated with the quality of the lead. The Lead Score may be calculated, for example, as a percentage of the value of data entered about a lead. The Lead Price, for example, may be a suggested or provided price that a user can pay to purchase a lead. The Lead Price, for example, may be calculated, for example, based on a weighted product of the Lead Score and the suggested value of the lead. Various other calculations may be made to determine a User Score, a Lead Score and/or a Lead Price.

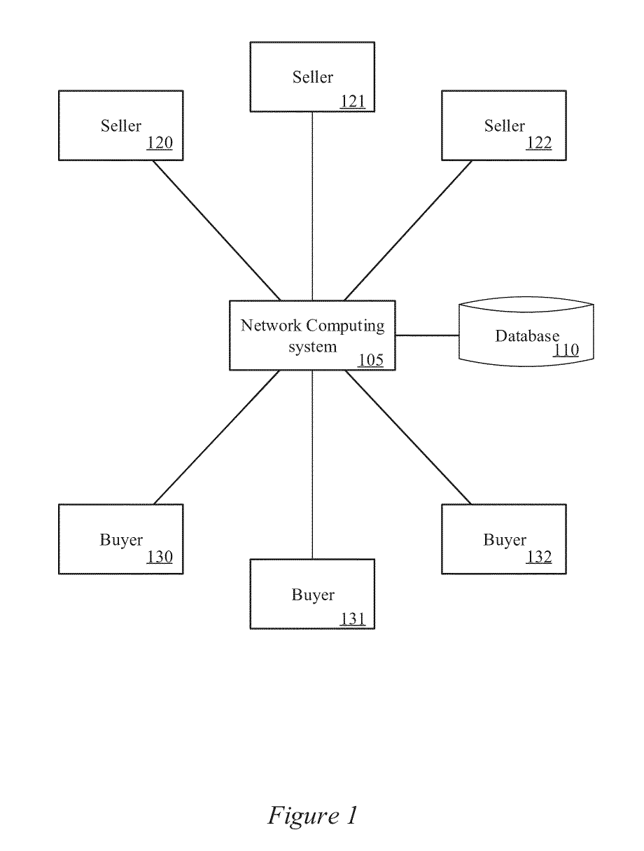

FIG. 1 shows network computing system 105 coupled with database 110, sellers 120, 121 and 122, and buyers 130, 131 and 132 according to some embodiments described herein. The sellers 120, 121 and 122 and/or buyers 130, 131 and 132 may generally be referred to as users.

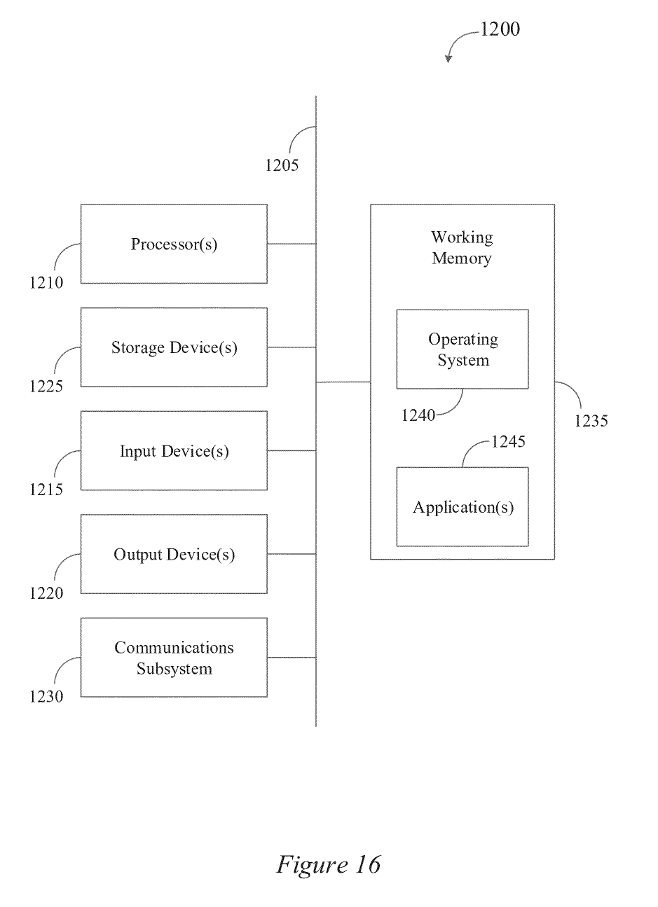

In some embodiments, network computing system 105 and/or database 110 can be hosted by a server or a plurality of servers. Network computing system 105 and/or database 110 can be hosted in the cloud. In some embodiments, network computing system 105 may include one or more webservers and/or be in communication with one or more webservers. In some embodiments, network computing system 105 can include components of computational system 1600 shown in FIG. 16. Network computing system 105 may include one or more webservers that provide a marketplace for sales leads, provide content listing sales leads to users and/or provide a webform with a plurality of fields where users can enter information about sales leads.

In some embodiments, database 110 may include plurality of contact information of a contact that may be provided by sellers 120, 121 and 122 along with information about a sales lead for the contact. Moreover, network computing system 105 can include a webserver that provides an online marketplace to sellers 120, 121 and 122 and/or buyers 130, 131 and 132 via the Internet.

In some embodiments, a sales lead can be published to a webpage hosted by the network computing system 105 along with a Lead Score, a Lead Price and/or a User Score. In some embodiments, a title, summary or brief description of the lead may also be published. In some embodiments, a lead may be published with information showing that data about a lead is available only to the purchaser of the lead. Once purchased, this data about the lead that is available and unpublished may be provided to the purchaser such as, for example, through a webpage or via email.

In some embodiments, a lead can be sold to a set number of purchasers, a single purchaser, or an unlimited number of purchasers. In some embodiments, the price of a lead may vary depending on the number of times the lead has previously been purchased. A Lead may also include sales data.

A lead can include any data about consumer that is about to purchase a product. In some embodiments, a lead can be data about an eminent purchase need. A lead can also include market data about potential purchasers or other purchasers. A lead may also include a tip about a potential customer.

A User Score (or member score) may represent the trustworthiness of a user. The User Score may be determined based on any number of factors. For example, the User Score may be the average of a user's sold lead ratings provided by buyers. Lead ratings may include any scale. In some embodiments, a user without any ratings may have a default User Score such as, for example, 20. A user rating may be expressed in any number of ways such as for example, a number, a color, a percentage, one or more stars or other graphics, etc.

In some embodiments, a User Score (or User Score or seller's score) may also be determined based on, for example, values related to the frequency of visits of the user, number of leads sold by the user, the number of leads purchased by the user, the number of leads posted and not sold by the user, the number of leads that sold out, the number of leads that sold, the number of posted lead shares that include the user, the number of the user's posted lead views (or hits), the number of friends invited by the user, the number of friend invites accepted, the number of social followers (Twitter, Facebook, LinkedIn, etc.) of the user, third-party ratings (e.g., Klout), the length of membership (e.g., based on the registration date), the types of and/or numbers of badges collected (e.g., gamification), account verifiability (e.g., the entry of the user's driver's license, passport, public record information), the quantity of personal information provided by the user, the user's credit score, a background check on the user, the average of past lead scores of the user, etc.

In some embodiments, a User Score can be determined based on any number of factors. A User Score, for example, can indicate the trustworthiness of the member. A User Score can also indicate the likelihood that the seller is a bona fide seller. The User Score can be a function of a peer review score (that may or may not be normalized), activity level of the member, feedback from other members (e.g., members the salesperson has sold to in the past), the number of leads sold, the number of leads purchased, the amount of personal data the member has entered into the system, etc.

In some embodiments, a User Score can be calculated from a peer review score received from another web services (possibly weighted based on components being reviewed) plus the member's activity level (e.g., the number of leads sold and/or bought, and/or the amount of feedback left for other members) plus the amount of personal data the member has entered (e.g., verified personal data).

In some embodiments, a Lead Score (e.g., data score or information score) can be determined based on any number of factors. A Lead Score, for example, can indicate the quality of the lead that is for sale by a seller. For example, the Lead Score can be a rating that may be provided to a potential buyer that can give the buyer some level of confidence regarding the quality of the lead being offered for sale. A Lead Score can be calculated in a number of different ways.

In some embodiments, a Lead Score can be calculated based on a function that includes the amount of data available about the score. For example, a lead score may be determined based on a percentage of data that has been entered about a lead compared with the total amount of data that could have been entered about the lead. As a further example, the availability of some data types may be more heavily weighted than other data types. For example, contact information may be more heavily weighted than other data types.

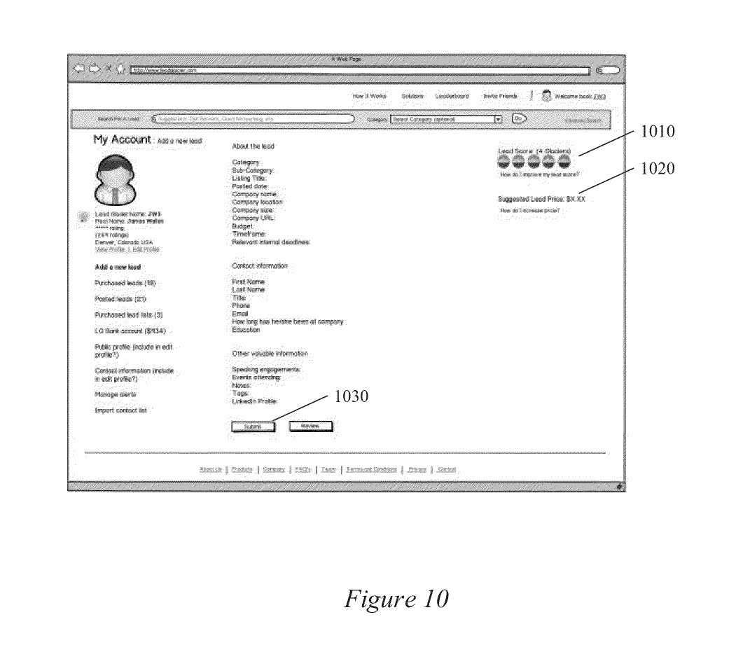

In some embodiments, a Lead Score can be computed based on a function of the number of fields completed in an online form for a specific lead (e.g., FIG. 10), the amount or quality of information provided about the lead, and/or the User Score of the user providing the lead. In some embodiments, some fields may more heavily influence the Lead Score than other fields.

In some embodiments, a Lead Score may be calculated, for example, as a percentage of the value of data entered about a lead.

In some embodiments, the Lead Score can be normalized based on the maximum number of points possible for a Lead Score for a given lead.

In some embodiments, the Lead Score can be a calculated score that is based on a scale of 1-10 (1=lowest, 10=highest). For example, the Lead Score can be one tenth of the Lead Points rounded up to the nearest 0.5.

In some embodiments, the Lead Score can be calculated based on the Lead Points, the gross sales value of the lead, a weighting based on the gross sales value of the lead, and/or the user rating.

In some embodiments, the Lead Score may be a function of the lead points associated with a data, gross sales value weight associated with the data, and a user rating associated with the user entering the data.

In some embodiments, the Lead Score can be weighted based on contact information, contact level within a company, and/or the gross sales value of the lead.

In some embodiments, the Lead Score can be calculated from the following function: number of fields completed+Field Multipliers+User score/Highest User Score.

In some embodiments, a Lead Score can be determined, for example, by the number fields of a webpage with data entered. As another example, the Lead Score can be determined by the number of data fields related to the lead in database 110. As yet another example, some fields in either the webpage or a database may be weighted by any amount. As yet another example, the Lead Score can be determined based on the number of fields completed plus field multipliers (including “notes”) plus the seller's User Score (possibly weighted by a User Score multiplier and/or normalized based on the highest possible User Score).

In some embodiments, the Lead Score can be the sum of all the Data Points assigned to the data entered by a user at each data entry field. For example, data entered into each data entry field can be assigned points based on a number of factors such as, for example, the number of characters entered in the data entry field, the value (or magnitude) of the characters in the data entry field, the type of data entered in the data entry field, and/or the amount of data entered in the data entry field, etc. In some embodiments, different data entry fields may be given a different weight or a different number of Data Points based on various factors, based on whether data was entered in the field, and/or a minimum amount of data was entered into the field than other data entry fields. In some embodiments, data entered in to different fields may be assigned

Data Points based on one or more sub-fields or based on the type of date entered in the field such as, for example, a checkbox data entry field or a radio button data entry field. For example, the size of the company related to the lead may result in a Data Point value. As another example, the title of the contact for the lead may result in a Data Point value. As another example, the type of telephone information provided in the lead may result in a higher Data Point value.

For example, Data Points can be assigned to user-entered data based on the following table.

| | | |
|---|---|---|
| User Entered Data | Sub-Fields | Data Points |

| | |
|---|---|
| Contact First Name | 1 |
| Contact Last Name | 1 |
| Company Size | 1 |

| | | | |
|---|---|---|---|
| Company Size | 0-25 | MM | 4 |
| | 26-50 | MM | 5 |
| | 51-100 | MM | 6 |
| | 101-250 | MM | 7 |
| | 251-500 | MM | 8 |

| | | |
|---|---|---|
| | 501-1 B | 9 |
| | 1B ++ | 10 |
| Contact Title | C-Level | 10 |
| | SVP | 9 |
| | VP | 8 |
| | Director | 7 |
| | Manager | 6 |
| Contact Phone | Corporate | 1 |
| | Assistant | 2 |
| | Desk | 8 |
| | Mobile | 10 |
| Contact Email | | 10 |
| Company Phone | | 1 |
| Company Address | | 1 |
| Company URL | | 1 |
| Lead Name | | 1 |
| Lead Description (open | | 1 |
| text field) | | |
| Keywords (Tags) | | 1 |
| Lead Industry | | 1 |
| Lead-Gross Sales | Not Sure/Default | 0 |
| Value | 1-10k | 3 |
| | 11-20k | 4 |
| | 21-50k | 5 |
| | 51-100k | 6 |
| | 101-250k | 7 |
| | 251-500k | 8 |

| | | |
|---|---|---|
| 501-1 | MM | 9 |
| 1 | MM +++ | 10 |

| | | |
|---|---|---|
| Lead-Net Sales Margin | Not Sure/Default | 0 |
| | 0-10k | 3 |
| | 11-20k | 4 |
| | 21-50k | 5 |
| | 51-100k | 6 |
| | 101-250k | 7 |
| | 251-500k | 8 |

| | | | |
|---|---|---|---|
| | 501-1 | MM | 9 |
| | 1 | MM +++ | 10 |
| Timing of Lead | | | 1 |
| Notes (open text field) | | | 10 |

In some embodiments, some user-entered data may be designated as open text fields in the chart such as, for example, the notes user-entered data and/or the lead description user-entered data. This data, for example, may be entered via an open text field. In open text fields data may be assigned points based on the number of characters in the user-entered data.

In some embodiments, different keywords in the keywords user-entered data may be assigned different Data Point values based on the relative value of and/or demand for leads associated with the keywords.

The gross sales value (GSV) may be entered by the seller and may represent the value of the projected final sale if the needs of the lead are met. In some embodiments, Data Points may be weighted based on various factors. For example, a weight may be assigned to one or more values user-entered data. These weights may be changed or revised based on any factor. In the example shown in the following chart, a weight can be determined based on the gross sales value (GSV) of the projected final sale. In some embodiments, other user-entered data may also be associated with a weight.

| GSV | Lead Points | Weight |
|---|---|---|
| 1-10k | 3 | 75 |
| 11-20k | 4 | 150 |
| 21-50k | 5 | 175 |
| 51-100k | 6 | 300 |
| 101-250k | 7 | 350 |
| 251-500k | 8 | 375 |

| | | | |
|---|---|---|---|
| 501-1 | MM | 9 | 750 |
| 1 | MM +++ | 10 | 1000 |

The Lead Price (or suggest lead price), for example, may be a suggested or provided price that a user can pay to purchase a lead. The Lead Price, for example, may be calculated, for example, based on a weighted product of the Lead Score and the suggested value of the lead. Various other factors can be used to calculate the Lead Price.

In some embodiments, a Lead Price can be calculated based on a function that includes the Lead Score, the lead's potential gross sales value (GSV), and/or the User Score.

In some embodiments, a Lead Price can be calculated from one plus the ratio of the Lead Score and the maximum possible Lead Score times the lead's potential gross sales value and times a lead generation factor (e.g., 0.0001, 0.001, 0.01, 0.1, etc.) multiplied by one plus the ratio of the User Score and the maximum possible User Score. Various other scaling factors can be used in conjunction with any value.

In some embodiments, if the seller fails to provide the lead's potential gross sales value, the suggested lead price can be a set amount (e.g., $50, $100, $500, $100, etc.) or some multiple of the Lead Score. In some embodiments, the set amount can be based on the market related to the lead or other considerations.

In some embodiments, the Lead Price may be calculated using the following function: Lead Price=(Lead Score/Max Possible Lead Points+1)*GSV Weight*(User Rating/Max User Rating+1).

In some embodiments, the Lead Price may be calculated using the following function: Lead Price=(Total Lead Points/Max Possible Lead Points+1)*(GSV*GSV %)*(User Rating/Max User Rating+1). Where GSV % can be, for example, 1%, 2%, 3%, 4%, 5%, etc.

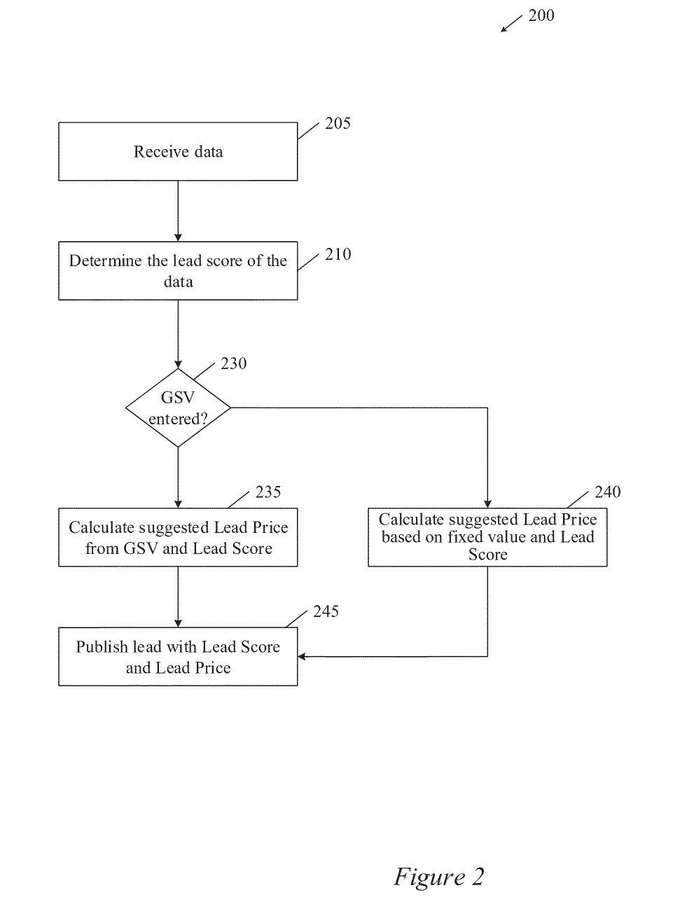

FIG. 2 is a flowchart of an example process 200 of determining a distribution strategy for distributing data to storage blocks of a storage network, according to at least one embodiment described herein. One or more steps of the process 200 may be implemented, in some embodiments, by one or more components of Network Computing system 105 of FIG. 1 and/or with computational system 1600 in FIG. 16. Although illustrated as discrete blocks, various blocks may be divided into additional blocks, combined into fewer blocks, or eliminated, depending on the desired implementation.

Process 200 begins at block 205 where data related to a lead is received. The data can be entered from the webpage such as, for example, the webpage shown in FIG. 10. The data may be received from another computing system in any way.

At block 210, the Lead Score can be computed. The Lead Score can be computed, for example, using any method, process or algorithm described herein from the data received in block 205. Embodiments described herein provide a number of example techniques for computing the Lead Score.

At block 230 it can be determined if the data includes a gross suggested value (GSV). If the data does include the GSV, then process 200 proceeds to block 235 where a Lead Price may be calculated based on a function of the gross suggested value and/or the Lead Score. Embodiments described herein provide a number of example techniques for computing the Lead Price. If the data does not include the GSV, then process 200 proceeds to block 240 where the lead price can be computed based on a fixed value and/or based on the Lead Score.

In some embodiments a user may also enter a Lead Price into a data entry field. The Lead Price, for example, may represent a price the seller is willing to sale the lead. The Lead Price may also be calculated based on the data entered about the lead.

Process 200 then proceeds to block 245 where the Lead Price and/or the Lead Score is published on webpage by network computing system 105. The Lead Price and/or the Lead Score may be published along with a description of the lead and a description of the data that is available but not published.

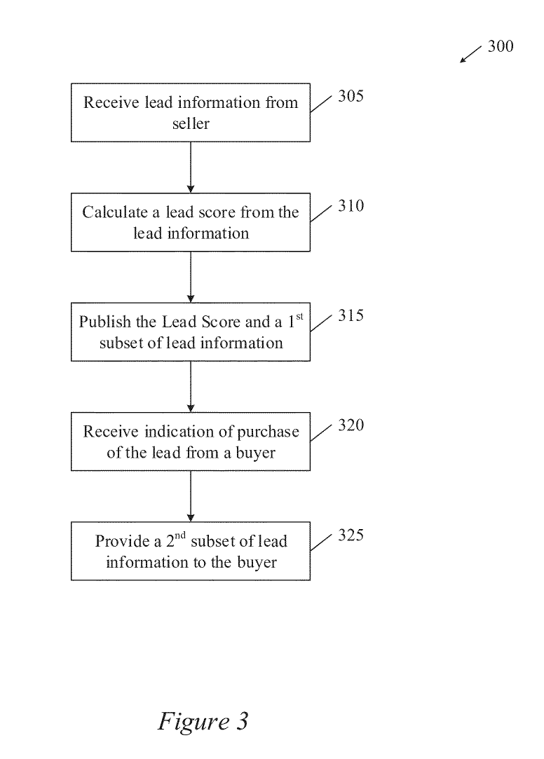

FIG. 3 is a flowchart of an example process 300 for selling a lead according to some embodiments described herein. One or more steps of the process 300 may be implemented, in some embodiments, by one or more components of Network Computing system 105 of FIG. 1 and/or with computational system 1600 in FIG. 16. Although illustrated as discrete blocks, various blocks may be divided into additional blocks, combined into fewer blocks, or eliminated, depending on the desired implementation.

Process 300 can start at block 305, where information about a lead is provided by a seller. This information can be entered, for example, using the webpage shown in FIG. 10. As another example, the lead information can be provided by a webserver to another server. At block 310 a Lead Score can be computed from the lead information. This can be computed, for example, using any embodiment described herein. Alternatively and/or additionally a Lead Price can be computed from the lead information.

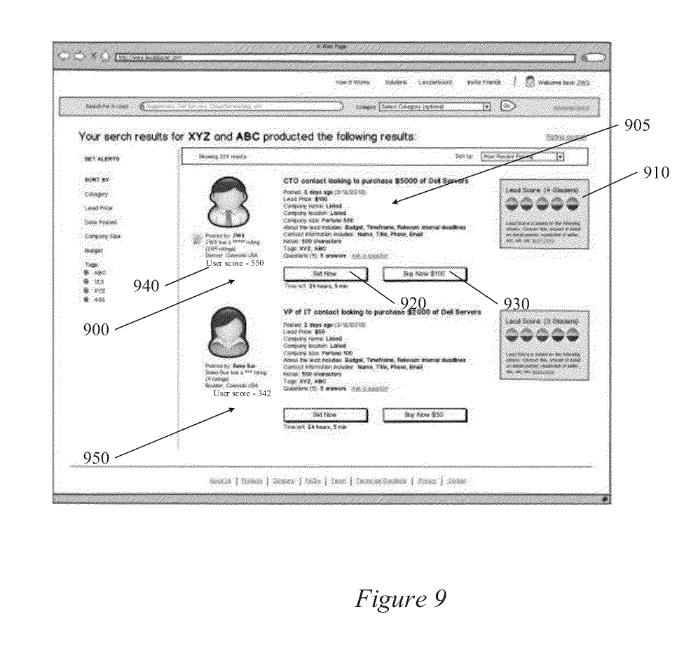

At block 315 the Lead Score and/or the Lead Price can be published along with a first subset of the lead information on a webpage such as, for example, in the manner shown in FIG. 9. In some embodiments, the first subset of the lead information may include a description of the lead, the title of the contact, the size of the company, the amount the lead is likely worth (e.g., GSV), and/or the products the contact is likely to buy. In some embodiments, the first subset of lead information may also specify that a second subset of lead information is available but not published. The second subset of lead information may include, for example, the name of the company, the geographic location of the company, contact information of the buyer (e.g., phone number(s), email address, etc.), budget information, timeframe information, etc. The first subset of lead information and/or the second subset of lead information may include any lead data stated or described herein among other data. In some embodiments, the user may select which information is provided in the listing. In some embodiments, network computing system 105 may list information provided in some fields and not provide information in other fields.

At block 320 an indication can be received that a buyer has purchased the lead. In some embodiments, the indication can be sent from a webserver to another server indicating that the lead has been purchased. In some embodiments, the indication can be received via a user selection and entry of payment details to purchase the lead.

At block 325, the second subset of the lead information may be published or sent to the user that purchased the lead. For example, the second subset of the lead information may be published on a webpage viewable to the user that purchased the lead. As another example, the second subset of the lead information can be emailed to the user that purchased the lead.

In some embodiments, blocks 305, 310 and/or 315 may be repeated any number of times so that lead information about different leads are received from a plurality of different users at various times. At block 315 the plurality of Lead Scores, Lead Prices, and/or a 1st subset of the lead information can be published in a lead marketplace that other users can peruse or browse as potential buyers of leads.

In some embodiments, users can provide information about leads that they are interested in such as, for example, by providing keywords of interest as part of a user profiled. Then, when leads associated with the keywords are received, the user can be notified that the lead is available for viewing and/or purchase.

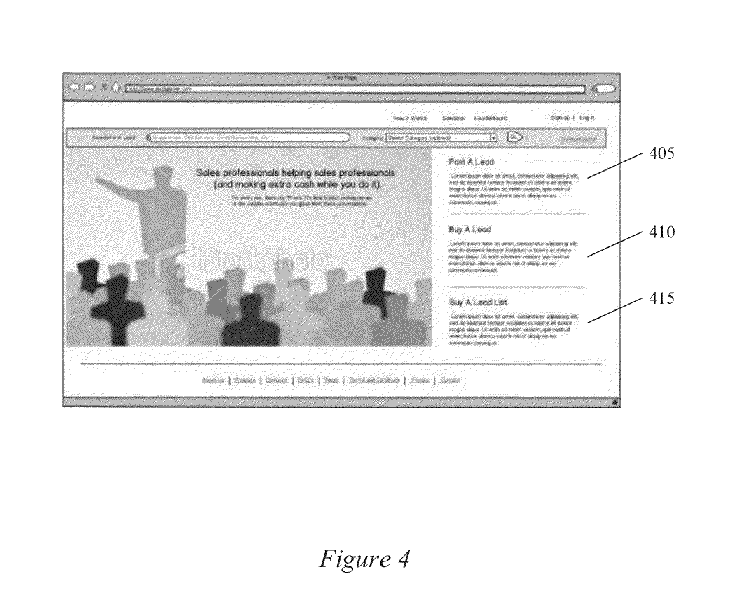

FIG. 4 is an example of a home page of a webpage providing a sales lead marketplace according to some embodiments described herein. At this page a user may choose to post a lead for sale 405, buy a lead 410, or buy a lead list 415. If the user chooses to post a lead for sale 405, the user may enter information about a lead they would like to sale. If the user would like to buy a lead 410, the user may view various postings of leads and choose to buy one or more leads.

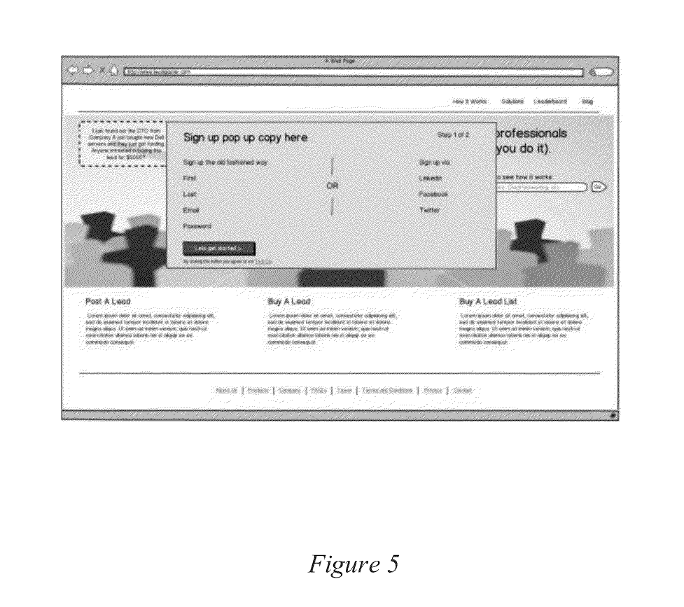

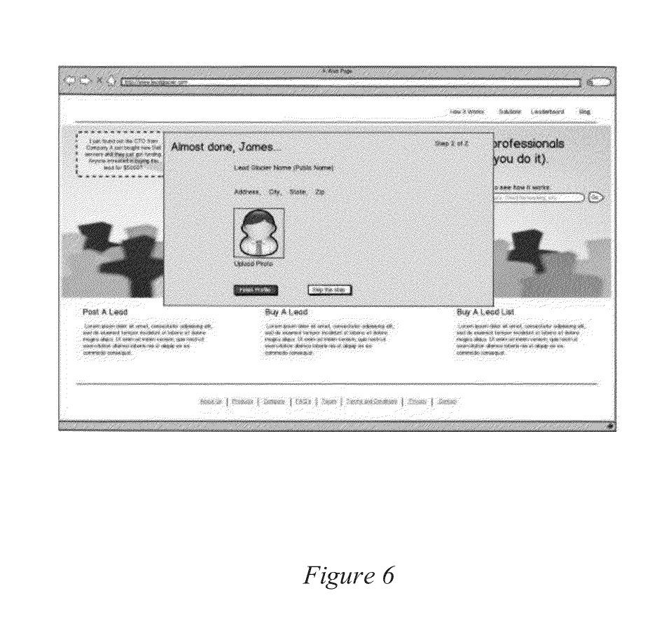

FIG. 5 is an example of a sign up page of a webpage providing a sales lead marketplace according to some embodiments described herein. Users can sign up using any method known in the art such as, for example, by providing contact information, a username, a password, a description of the user, payment information, leads types or keywords of interest, etc. FIG. 6 is an example of a web page for entering personal information of a webpage providing a sales lead marketplace according to some embodiments described herein.

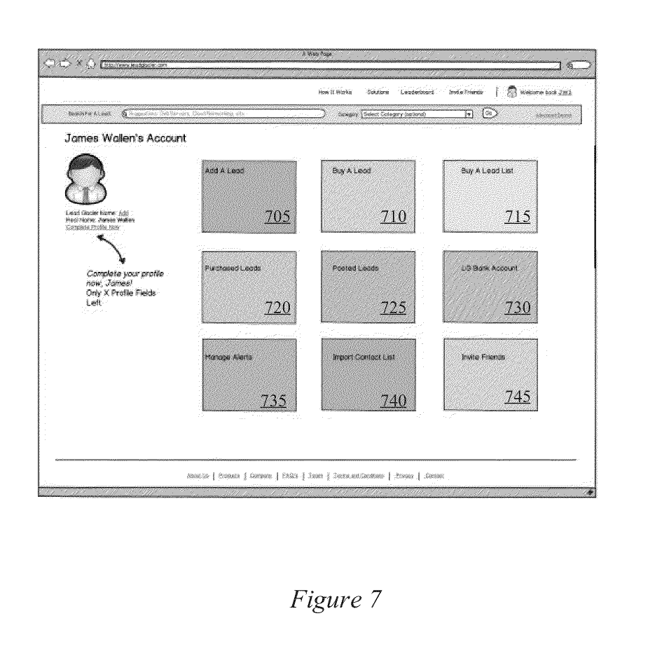

FIG. 7 is an example of a user's profile page shot of a webpage providing a sales lead marketplace according to some embodiments described herein. At this page a user can choose to post a lead by selecting button 705, buy a lead by selecting button 710, buy a lead list 715, purchase a block of leads selecting button 720, view leads posted by the user by selecting button 725, view their account by selecting button 730, manage alerts by selecting button 735, import contacts from other webpages, programs, or devices by selecting button 740, and/or invite friends to the market place by selecting button 745.

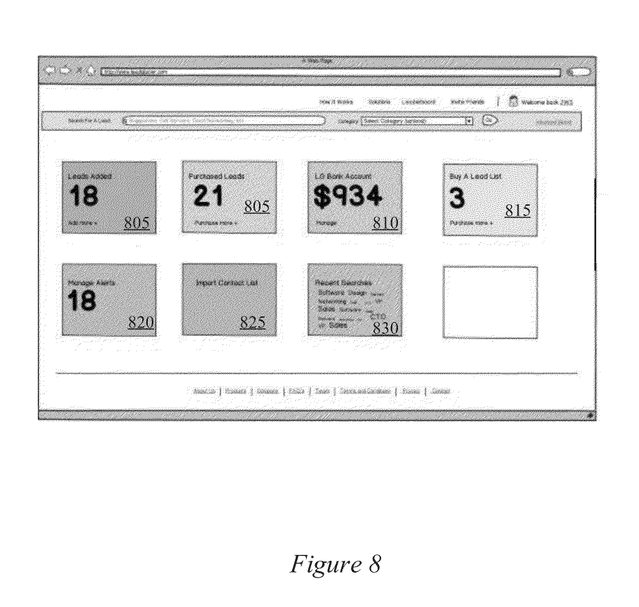

FIG. 8 is another example of a user's profile page shot of a webpage providing a sales lead marketplace according to some embodiments described herein. From this page, the user can see that they added 18 leads 805, and purchased 21 leads 810. The user can see that they earned $934 by selling leads 810, and have 3 leads on their buy a lead list 815. The user can see that they have 18 managed alerts 820. They can also import contacts 825 and see recent searches 830.

FIG. 9 is an example of a published webpage with a listing of leads that a user can purchase according to some embodiments described herein. This webpage shows two leads for sale. A first lead listing 900 includes a Lead Score 910, a Lead Price 930, user score 940, and/or an option to bid on the lead 920. The first listing 900 describes a listing for a CTO looking to buy $5000 in Dell servers. The first listing 900 may also include a first subset of data 905 that is published. This first subset of data 905 may include, for example, information specifying that the company name and company location is listed and can be viewed by the purchaser of the lead. The first subset of data 905 also specifies that the company is a fortune 500 company. The first subset of data 905 also specifies that other information is available only to the purchaser such as, for example, budget information, timeframe information, internal deadline information, etc. The first subset of data 905 also specifies that the name, title, email, and phone number of the contact for the lead is available and will be provided to the purchaser of the lead. The first subset of data 905 also specifies that 500 characters of notes will be provided to the purchaser of the lead and that a number of questions have been answered about the lead. Various other information may be published with the lead and/or be available only to the purchaser of the lead.

A user can purchase the lead by bidding on the lead in an auction style by selecting “Bid Now” button 920 and/or buying the lead for a fixed price by selecting the “Buy Now $100”. Some embodiments may use only sale leads through an auction or with a fixed price. In some embodiments, only a fixed number of leads may be sold.

Second lead listing 950 includes similar information about a lead for a VP of IT looking to purchase $2000 in Dell servers with Lead Score 960. Listing 950 also describes the type of information that will be provided to the purchaser of the lead.

FIG. 10 is an example of a page where a user can provide information about a lead they are selling according to some embodiments described herein. A Lead Score 1010 can be computed and published based on the amount of information about the lead provided by the seller. As shown, the seller can enter information about the lead that can include, for example, the lead category, sub-category, listing title, posting date, company name, company location, company size, company URL, budget for purchasing a product or service, timeframe for purchasing a product or service, relevant internal deadlines, and/or contact information, etc. The contact information can include, for example, the contacts name, email address, phone number(s), location, time at the company, the contacts position, contacts education, LinkedIn profile, and/or events the contact is planning to attend or speak at, etc. Other information can be requested and/or entered. As more and more information is entered about the lead, The Lead Score 1010 can be updated in real time based on the information entered. In this embodiment the Lead Score is scored from zero to five “Glaciers”, which are each represented by a blue circle. The Lead Score may also be represented by a number or other characters. Moreover, the lead price 1020, which may depend on the Lead Score, may also be updated in real time based on the information entered. When the submit button 1030 is selected the lead can be entered into network computing system 105 with the information provided.

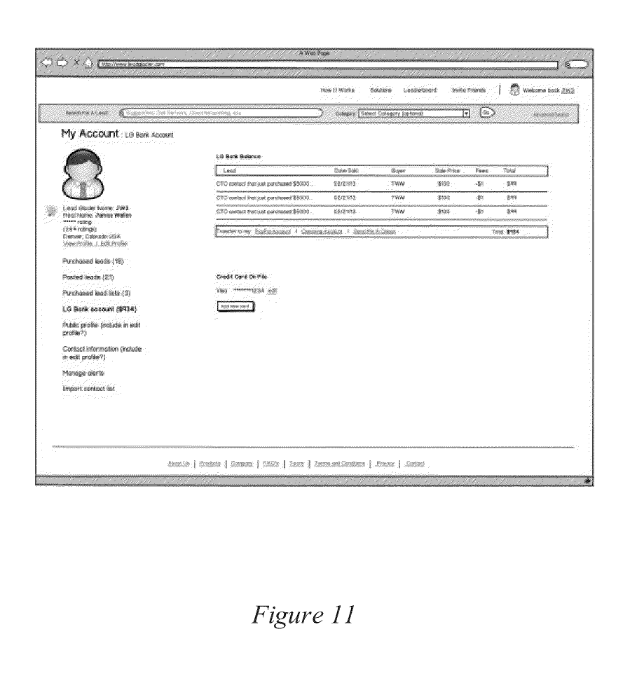

FIG. 11 is an example of a page listing leads a user has sold according to some embodiments described herein. This page also lists the amount the user has earned from each listing, the dates of sale, and the fees collected to list the leads.

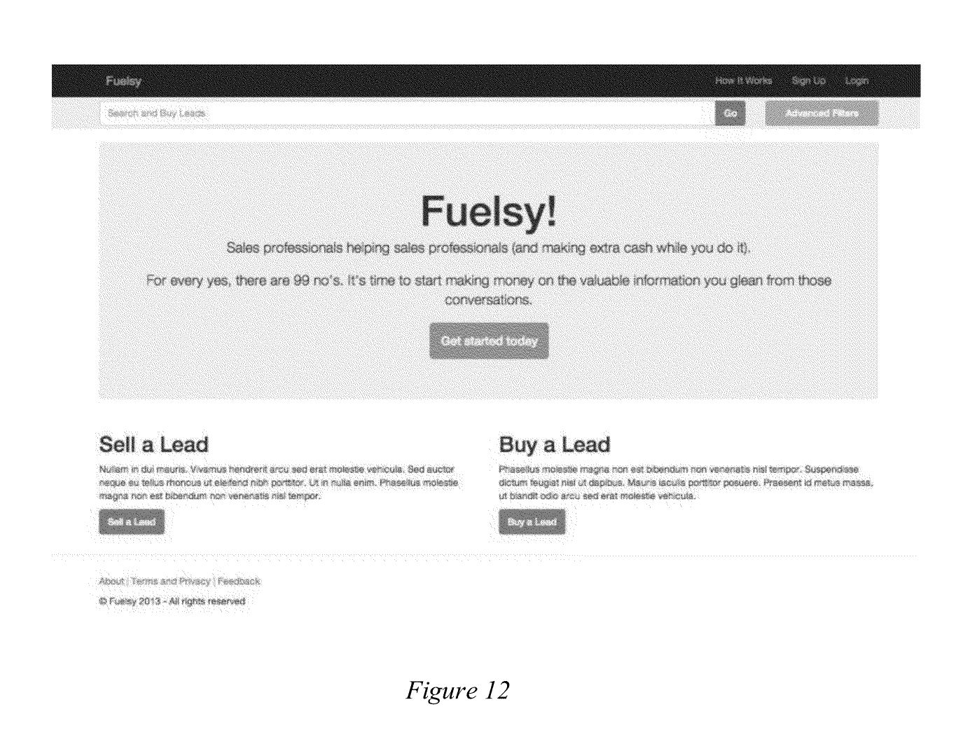

FIG. 12 is an example of a home page of a webpage providing a sales lead marketplace according to some embodiments described herein.

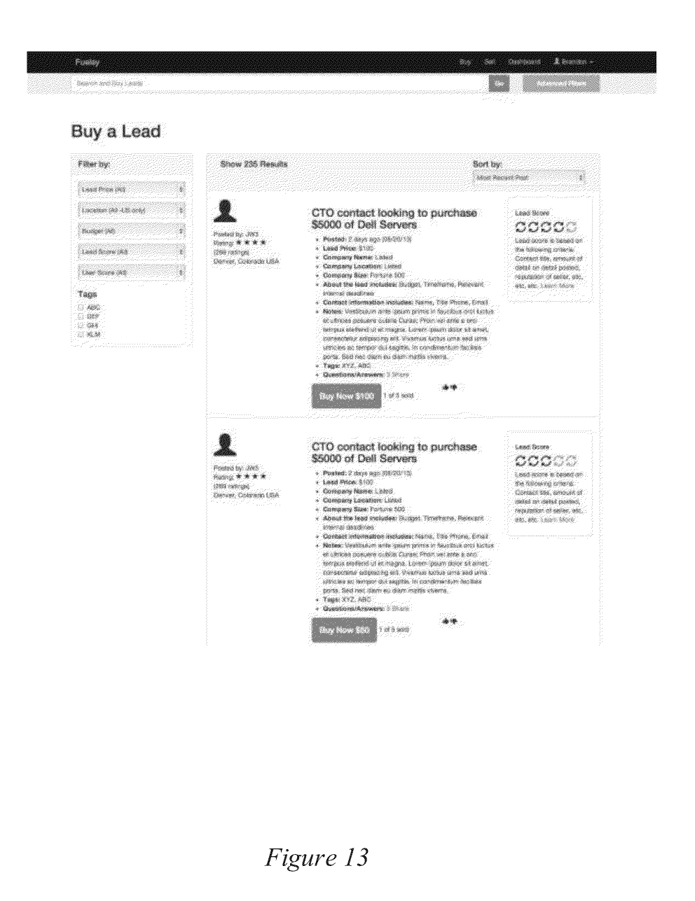

FIG. 13 is an example of a webpage with a listing of leads that a user can purchase according to some embodiments described herein.

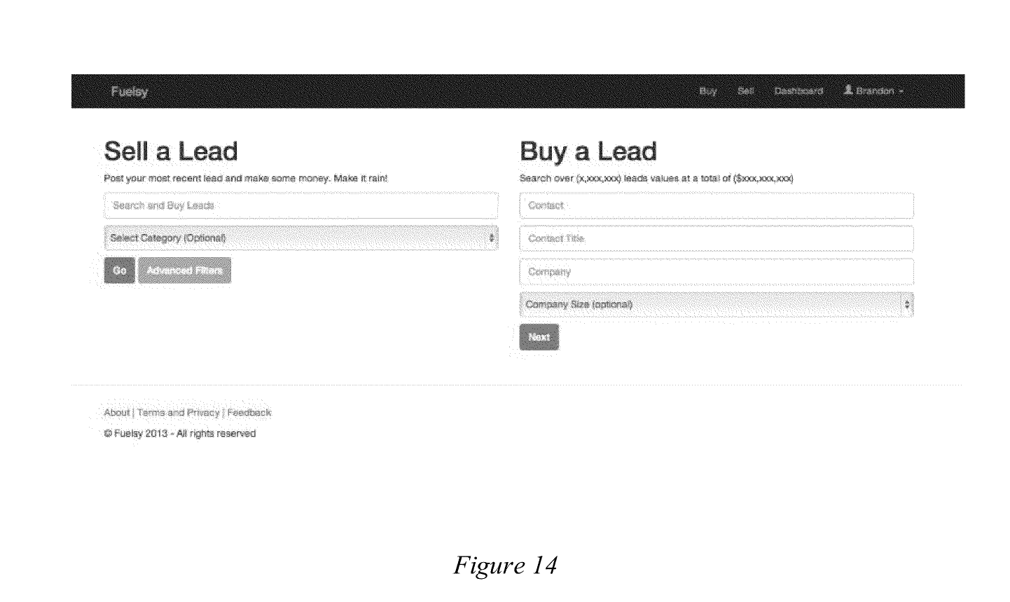

FIG. 14 is an example sign up page for selling or buying leads according to some embodiments described herein.

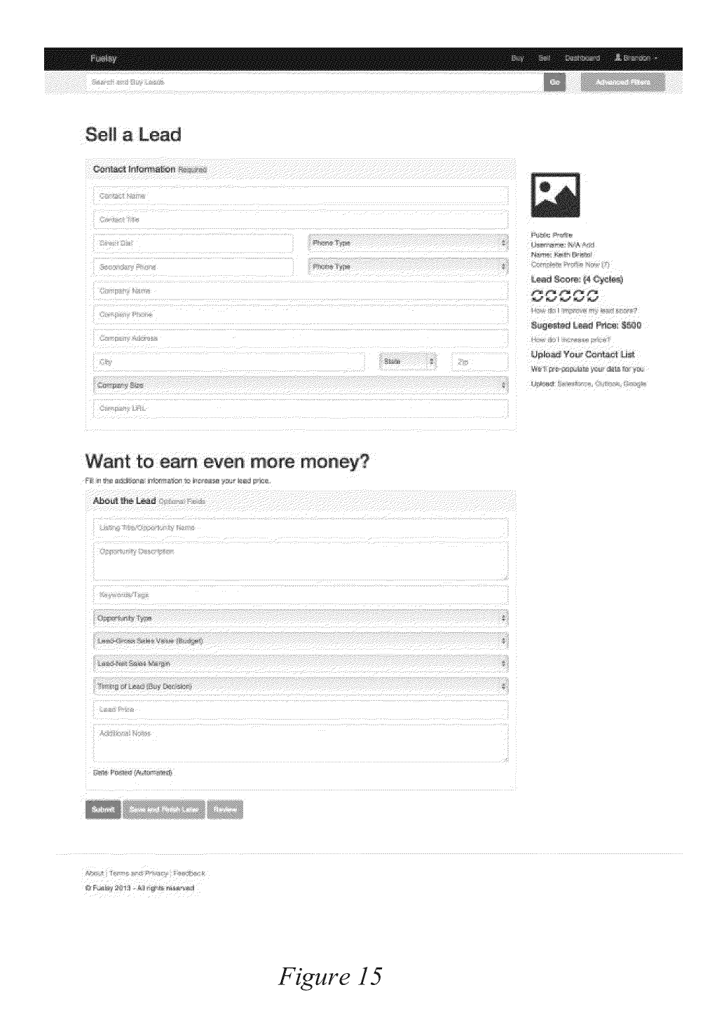

FIG. 15 is an example webpage having a plurality of fields that may receive data about a potential sales lead from a user according to some embodiments described herein. In this example, a plurality of fields is indicated as required. These fields include fields for collecting contact information about the lead. Various other data fields are provided that may be used to boost the Lead Score and/or the Lead Price (e.g., “suggested lead price”) for the lead. The Lead Score and/or the Lead Price can be calculated in real time based on the information received from user through the various fields on the webpage.

The computational system 1600, shown in FIG. 16 can be used to perform any of the embodiments described herein. For example, computational system 1600 can be used to execute methods 200 and/or 300. As another example, computational system 1600 can be used perform any calculation, computation, identification and/or determination described here. Computational system 1600 includes hardware elements that can be electrically coupled via a bus 1605 (or may otherwise be in communication, as appropriate). The hardware elements can include one or more processors 1610, including without limitation one or more general-purpose processors and/or one or more special-purpose processors (such as digital signal processing chips, graphics acceleration chips, and/or the like); one or more input devices 1615, which can include without limitation a mouse, a keyboard and/or the like; and one or more output devices 1620, which can include without limitation a display device, a printer and/or the like.

The computational system 1600 may further include (and/or be in communication with) one or more storage devices 1625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1600 might also include a communications subsystem 1630, which can include without limitation a modem, a network card (wireless or wired), an infrared communication device, a wireless communication device and/or chipset (such as a Bluetooth device, an 802.6 device, a WiFi device, a WiMax device, cellular communication facilities, etc.), and/or the like. The communications subsystem 1630 may permit data to be exchanged with a network (such as the network described below, to name one example), and/or any other devices described herein. In many embodiments, the computational system 1600 will further include a working memory 1635, which can include a RAM or ROM device, as described above.

The computational system 1600 also can include software elements, shown as being currently located within the working memory 1635, including an operating system 1640 and/or other code, such as one or more application programs 1645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1625 described above.

In some cases, the storage medium might be incorporated within the computational system 1600 or in communication with the computational system 1600. In other embodiments, the storage medium might be separate from a computational system 1600 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 1600 and/or might take the form of source and/or installable code, which, upon compilation and/or installation on the computational system 1600 (e.g., using any of a variety of generally available compilers, installation programs, compression/decompression utilities, etc.) then takes the form of executable code.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed is:

1. A system comprising:
one or more processors; and
one or more non-transitory, tangible computer readable mediums communicatively coupled to the one or more processors and storing executable instructions executable by the one or more processors to perform or control performance of operations comprising:
receiving user entered information from a first user through a network;
computing an information score and an information price based on at least a first subset of the user entered information;
publishing the information score and the information price in a manner that is accessible by a plurality of users through the Internet and in a manner such that at least a second subset of the user entered information is indicated as being available but is not published;
receiving an indication that a second user has paid the information price; and
providing the second subset of the user entered information to the second user through the network.

2. The system according to claim 1, wherein the user entered information comprises data selected from the list consisting of: contact name information associated with the data, company name information associated with the data, company size information associated with the data, contact title information associated with the data, a contact phone number associated with the data, a contact email address associated with the data, a company phone associated with the data, a company address associated with the data, a company webpage associated with the data, a name of a lead associated with the data, a lead type associated with the data, a description associated with the data, a gross sales value associated with the data, a sales margin associated with the data, time information associated with the data, and notes associated with the data.

3. The system according to claim 1, wherein the information score is computed based on a function including at least a user score associated with the first user, wherein the user score indicates the trustworthiness of the first user.

4. The system according to claim 1, wherein the user score is computed based on a function including at least data selected from the list consisting of a peer review score of the first user, an activity level indication of the first user, feedback about the first user from other users, a number indicating the number of leads sold by the first user, a number indicating the number of leads purchased first user, and an amount of personal data the first user has entered into the system.

5. A method comprising:
receiving at a computing system user entered data that was entered by a first user into a plurality of data entry fields published by a first webpage hosted by a first webserver, wherein the user entered data comprises at least first data entered into a first field of the plurality of data entry fields, second data entered into a second field of the plurality of data entry fields, and third data entered into a third field of the plurality of data entry fields;
computing at the computing system a data score based on a function including at least the first data and the second data; and
publishing the data score and the first data on a second webpage hosted by a second webserver, but not publishing the second data on the second webpage.

6. The method according to claim 5, further comprising publishing information on the second webpage indicating that the second data is available but not published.

7. The method according to claim 5, further comprising:
receiving an indication that a second user has purchased access to the second data; and
publishing the second data on a third webpage that is accessible to the second user.

8. The method according to claim 5, wherein the computing the data score based on a function including at least the first data and the second data further comprises:
determining a number of characters comprising the first data; and
computing the data score based on a function including at least the number of characters.

9. The method according to claim 5, wherein the data score is computed based at least on a sliding scale of the first data.

10. The method according to claim 5, further comprising:
receiving an indication that a second user has purchased access to the second data; and
sending an email including the second data to the second user via email.

11. The method according to claim 5, wherein the third data comprises a value associated with the user entered data, wherein the method further comprises:
determining a suggested lead price from the data score and the third data; and
publishing the suggested lead price on the second webpage hosted by the second webserver.

12. The method according to claim 11, further comprising publishing the third data on the second webpage hosted by the second webserver.

13. The method according to claim 5, wherein the first webserver and the second webserver comprise the same webserver or the same plurality of webservers.

14. The method according to claim 5, wherein the data score is computed based on a function including at least a user score associated with the first user, wherein the user score indicates the trustworthiness of the first user.

15. The method according to claim 14, wherein the user score is computed based on a function including at least one or more data selected from the list consisting of a peer review score of the first user, an activity level indication of the first user, feedback about the first user from other users, a number indicating the number of leads sold by the first user, a number indicating the number of leads purchased first user, and an amount of personal data the first user has entered into the system.

16. The method according to claim 14, wherein the first data, the second data, and/or the third data comprise data selected from the list consisting of: contact name information associated with the data, company name information associated with the data, company size information associated with the data, contact title information associated with the data, a contact phone number associated with the data, a contact email address associated with the data, a company phone associated with the data, a company address associated with the data, a company webpage associated with the data, a name of a lead associated with the data, a lead type associated with the data, a description associated with the data, a gross sales value associated with the data, a sales margin associated with the data, time information associated with the data, and notes associated with the data.

17. A method comprising:
receiving at a computer system user entered information from a first user through a network, wherein the user entered information includes contact information and value information associated with at least a subset of the user entered information;
computing at the computer system a user score associated with the first user that indicates the trustworthiness of the first user;
computing at the computing system an information score based on a function including at least the contact information and the user score;
computing at the computing system an information price based on a function including at least in part on the value information;
publishing the information score and the information price in a manner that is accessible by a plurality of users through the Internet and in a manner where at least a second subset of the user entered information is indicated as being available but is not published;
receiving an indication that a second user has paid the information price; and
providing the second subset of the user entered information to the second user through the network.

18. The method according to claim 17, wherein the information price is computed based on a function including at least on the value information and the information score.

19. The method according to claim 17, wherein the user entered information includes text data, and wherein computing at the computing system the information price further comprises:
determining a number of characters comprising the text data; and
computing the data score based on a function including at least the number of characters.

20. The method according to claim 17, wherein the data score is computed based at least on a sliding scale of a subset of the contact information.
